(19) United States
(12) Patent Application Publication
(10) Pub. No.: US 2005/0133516 A1
(43) Pub. Date: Jun. 23, 2005

(54) Anti-splatter cover for drain pans

(76) Inventor: Russ Dyer, Arco, ID (US)

Correspondence Address: National IP Rights Center, LLC, Suite 400, 550 Township Line Road, Blue Bell, PA, 19422, US

(21) Appl. No.: 10/797,477

(22) Filed: Mar. 10, 2004

Related U.S. Application Data
(60) Provisional application No. 60/531,926, filed on Dec. 22, 2003.

(51) Int. Cl. B67C 11/04

(52) U.S. Cl. 220/694

(57) ABSTRACT

An anti splatter cover is disclosed. The anti splatter cover includes a substantially rectangular mesh cover for covering the drain pan, and at least one protrusion mounted perpendicularly to the substantially rectangular mesh cover.

### CLAIM OF PRIORITY

This Application claims priority to Provisional Patent Application No. 60/531,926 filed Dec. 22, 2003.

### FIELD OF THE INVENTION

The present invention relates to anti splatter covers in general, and to anti splatter covers for drain pans in particular.

### BACKGROUND OF THE INVENTION

Draining an engine is a messy job, as anyone who has engaged in the task is aware. The oil drips down from the engine and is apt to spill all over the ground underneath the engine. Typically, what is done is that a pan is placed under the engine to catch the oil and keep it from spilling onto the ground. However, even with a pan, the oil tends to splatter once it strikes the pan after having dripped down from the engine due to the velocity of the drops as they are falling from the engine into the pan, and still causes a bit of a mess in the surrounding area to the drip pan.

U.S. Pat. No. 3,944,199 is directed towards a work holder mounted on a catch pan or drain that provides a flat grid to support an oil or grease carrying portion of a vehicle or the like. The flat grid is supported by and positioned centrally above the catch pan, which is substantially larger than the oil carrying portion of the vehicle. The catch pan is supported by a hollow central mounting tube through which any liquids collected in the pan may drain into a storage container for disposal in a routine manner. The storage container may support the mounting tube.

U.S. Pat. No. 4,332,282 is directed towards a technique for both cleaning up the crankcase oil changing process and recycling the oil for use as heating oil or, after refining, as lubricating oil, utilizes a shallow pan with a funnel defined on one edge which captures used oil from the engine crankcase, an oil can opener spout which makes a circular hole in the top of the oil can from which the fresh oil is poured into the crankcase after the used oil is drained, and a series of plugs which are inserted into the openings made by the oil can opener spout so that the used crankcase oil can be poured back into the cans the new oil came in by utilization of the special oil drip pan with the funnel extension.

U.S. Pat. No. 3,918,542 is directed to an oil drip pan for use on the underside of a vehicle as an auxiliary pan for catching leaking or dripping oil from the preexisting vehicle oil pan. The oil pan includes means for securing the pan beneath the preexisting vehicle oil pan and is adapted to be mounted on most vehicles. The pan further includes means for absorbing most of the dripping oil and for guiding dripping or leaking oil to a particular location on the pan for subsequent drainage therefrom.

U.S. Pat. No. 5,562,131 is directed towards a drip-free oil drain pan comprising a tray. The pan has a lower imperforate plate with an enlarged first section of a generally circular configuration and has co-extensive therewith, in a common plane, a second section in a generally circular configuration. The first and second sections are coupled together at a common throat area of reduced size. The drain pan further comprises an upstanding side wall for the plate including a first side wall extending upwardly from around the majority of the first section of the planar plate except in the reduced throat area. Also provided is a second side wall extending upwardly from around the majority of the second section of the planar plate except in the reduced throat area and formed as an extension of the first side wall. The second side wall is formed with planar steps having a greater diameter at varying elevations above the planar surface for accommodating and supporting oil filters of different sizes with a channel formed in the second side wall at a location diametrically opposed from the reduced throat area to define a curved chute for the movement of oil from the filter onto the entire upper surface of the imperforate plate.

U.S. Patent Application No. 20030029412 is directed towards the oil pan structure which comprises an oil pan separator, disposed within an oil pan, for separating a main chamber provided with a suction port disposed therewithin and a sub chamber provided with no suction port from each other, the oil pan separator having a recess forming the main chamber, the main chamber communicating with the inside of an engine block, the recess being formed with communication holes for communicating the main and sub chambers to each other. The sub chamber is formed so as to surround the main chamber as a whole, whereas the outer face of the bottom part of the oil pan separator and the inner face of the bottom part of the oil pan are not in contact with each other. Therefore, raising the temperature of engine oil within the main chamber earlier can lubricate the engine more effectively.

U.S. Pat. No. 4,246,982 is directed towards a car ramp and drip pan assembly for placement under parked motor vehicles to catch fluid and particle drippings therefrom including a rectangular tray for catching the drippings, a pair of elongated racks positioned in the tray parallel to the sides of the tray and upon which the vehicle is driven thus spacing the vehicle wheels above the bottom of the tray so that the wheels do not touch the drippings, and a ramp connected to the entrance edge of the tray enabling easy entry of a vehicle onto the racks. A pair of tire stops is selectively positionable on the racks for stopping the vehicle at a predetermined position on the assembly. The tray perimeter is formed of a continuous upstanding flange to contain the drippings within the tray. The ramp has a transverse slot formed in its underside to coactively fit onto the flange on the entrance edge of the tray. The racks and ramp have their upper surfaces corrugated to provide traction for the vehicle wheels. The tray has a garden hose drain attachment formed in the tray flange at an end of the tray to drain the drippings from the tray. The ramp and racks have their top surfaces coated with luminous material enabling easy visual entry of a vehicle on the assembly in darkness. The racks also have electrical heating elements formed therein to melt accumulated snow and ice thereon enabling quick draining of such melted snow and ice via the garden hose drain attachment.

U.S. Pat. No. 6,446,907 is directed to a helicopter drip pan apparatus for covering and sealing a structural opening in a helicopter. The drip pan apparatus includes a frame member adapted to mount to the structural opening of the helicopter. The frame member has an inwardly-facing peripheral surface extending around the frame member. The frame member and thus the surface have at least one linear portion. A drip pan is selectively affixed to the frame member. The drip pan includes an outwardly-facing peripheral groove which extends around the outside edge of the drip pan. Like the surface of the frame member, the groove has at least one linear portion. The perimeter of the drip pan conforms to the surface of the frame member. A seal member is disposed in the groove of the drip pan to sealingly engaging the surface of the frame member against fluid leakage therethrough.

U.S. Pat. No. 5,180,033 discloses an oil changer intended to encourage proper disposal of used motor oil. It is comprised of an outer container made of cardboard and an inner container of polypropylene and a tie device to seal the motor oil in the inner container. The polypropylene material is non-reactive with the petroleum products and additives found in used engine oil; its tensile strength is approximately 8,000-pounds/inch², rendering it durable enough to prevent inadvertent oil spillage; and it can withstand temperatures of up to 320 degrees F., making it possible to drain the engine oil into the inner container while the oil is hot. The tie device is of the cable tie variety, providing locking security against oil leakage. The sealed double containment of used engine oil within a durable outer container makes possible the safe and clean transportation, storage and handling of the oil changer during collection for recycling of both the used oil and the component parts of the oil changer itself.

U.S. Pat. No. 5,499,557 is directed towards a drain plug removing device including a removable socket located at the head of the device, which socket is adapted to securedly engage and hold the head of a threaded drain plug. The socket is fixedly coupled to the upper external member of a retaining socket holder, the lower section of which is disposed within a cavity of the device head in fixed engagement with a crown gear adapted for rotation within the cavity. A pinion gear is movably coupled within the head cavity to the crown gear. A tubular housing having a chamber in communication with the head cavity is fixedly connected to the device head. A drive shaft disposed within, and extending throughout the length of, the chamber is fixedly coupled at one of its ends to the pinion gear. At its other end, the drive shaft is fixedly coupled to a rotatable external handle positioned adjacent the end of the housing opposite the device head, whereby rotation of the handle is translated through the drive shaft and the gears to produce a simultaneous rotation of the socket holder, the socket and a drain plug engaged therein. Oil drain ports are included in the device head to allow excess oil to drain therefrom, and the invention may also include a separate portable receptacle into which the device head is placed to receive the excess oil that drains from the device head through its drain ports.

U.S. Pat. No. 4,274,645 is directed towards a drain oil collection tank for use in an automobile service station, the device including a thirty gallon tank mounted on a hand cart, a drain valve at the bottom of the tank, a screen covered funnel extending telescopically adjustable upward from a cover of the tank and an oil level gauge in the tank.

U.S. Pat. No. 4,673,081 is directed to a waste oil drain collector and storage container kit for collecting and storing waste fluid, such as oil, drained from the engine of motor vehicles. A disclosed embodiment comprises a rectangular receptacle, which, in oil collecting position rests on a broad, flat base, supporting a drain pan in the uppermost position. A lid is designed to cover the drain pan when the receptacle is placed on end with a handle uppermost, in carrying position. A particular feature of the receptacle is a cylindrical valve which is manually rotated through three positions, a first collecting position which opens a passage from the oil drain pan to a storage container; a second pouring position which closes the passage to the storage container from the oil drain pan and opens a passage from the storage container to an external dispensing spout; and a third carrying position in which the passages into and out of the storage container are closed, and a cap is screwed in place on the dispensing spout. Another feature is the use of the internal surface of the drain pan lid as a caddy for carrying tools for opening the oil cock and loosening the oil filter.

U.S. Pat. No. 4,702,290 is directed to a container for collecting oil that has a cover and a valve assembly to control the drawing of the collected oil into a household container, such as a plastic milk container. A support assembly is provided to hold the oil filter over the valve assembly so that it can also be drained. A threaded portion on the spout of the valve assembly insures a spill free pouring of the oil.

U.S. Pat. No. 6,173,856 discloses a liquid containment device for capturing and retaining any liquid falling into the device, such as from a leak, spill or run-off of another liquid container, where the device is designed to fit between the parallel rails of a railroad track with a railroad car positioned above, comprising a generally rectilinear pan or tray and a removable cover which directs rain water into a drain opening which corresponds to an apertured drain column rising from the bottom of the pan, such that with the cover in place rain water is directed into the drain column and passed underneath the pan rather than into the pan itself. Multiple pans may be connected in line through connector fittings in their end walls, or drain conduits may be connected to the fittings for removal of the liquid from the pan. Apertured grating members and absorbent mats may be placed within the pans. The pans may be used in conjunction with lateral pans positioned on the outside of the rails.

U.S. Pat. No. 6,558,769 is directed towards a receptacle for the collection of fluids. The receptacle includes a frame with an opening defined between a pair of sidewalls and the front and rear walls supported by the frame. The receptacle also includes a lower grate, a sorbent pad and an upper grate, all of which is received in the basin of the frame. The sorbent pad sandwiched between the upper and lower grate is prevented from moving and kept substantially flat, such that the sorbent pad may cover the entire opening. The front and rear walls further include tapered sections to secure the receptacle to the ground. In addition, the upper grate may also be hinged to the frame, providing an easier means to access the sorbent pad for periodic maintenance purposes. The preferred sorbent pad has properties that absorb various petroleum-based fluids while at the same time allowing water-based fluids to drain or seep through. The water may thereafter drain out of the frame through drain holes provided along the sidewalls or through the opening.

There is a need however, for a simple device that can easily be mounted on an oil drip pan and reduces the velocity of the falling oil so that spatter is greatly reduced. None of the above inventions meet this need.

### OBJECTS AND SUMMARY OF THE INVENTION

It is an object of the present invention to provide an anti splatter cover that can be mounted on a drain pan to reduce the amount of splatter from draining a liquid.

It is a further object of the present invention to provide an anti splatter cover that includes a substantially rectangular mesh cover for covering the drain pan, and at least one protrusion mounted perpendicularly to the substantially rectangular mesh cover.

It is yet a further object of the present invention to provide an anti splatter cover including a substantially rectangular mesh cover for covering the drain pan including a plurality of intersecting horizontal beams and vertical beams, and a plurality of conical protrusions, mounted perpendicularly at the intersections of the horizontal and vertical beams of the substantially rectangular mesh cover.

It is even a further object of the present invention to provide an anti splatter cover including a mesh cover for covering the drain pan, and at least one protrusion mounted perpendicularly to the substantially rectangular mesh cover.

In accordance with a first aspect of the present invention, a novel anti splatter cover is provided. The novel anti splatter cover includes a substantially rectangular mesh cover for covering the drain pan, and at least one protrusion mounted perpendicularly to the substantially rectangular mesh cover.

In accordance with another aspect of the present invention, a novel anti splatter cover is provided. The novel anti splatter cover includes a substantially rectangular mesh cover for covering the drain pan including a plurality of intersecting horizontal beams and vertical beams, and a plurality of conical protrusions, mounted perpendicularly at the intersections of the horizontal and vertical beams of the substantially rectangular mesh cover.

In accordance with yet another aspect of the present invention, a novel anti splatter cover is provided. The novel anti splatter cover includes a mesh cover for covering the drain pan, and at least one protrusion mounted perpendicularly to the substantially rectangular mesh cover.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a perspective view of an anti splatter cover in accordance with the present invention.

FIG. 2 is a perspective view of an anti splatter cover being mounted on a drain pan.

FIG. 3 is a perspective view of an alternative embodiment of an anti splatter cover in accordance with the present invention.

FIG. 4 is a perspective detail view of a crown shaped protrusion in accordance with the anti splatter cover of FIG. 3.

### DETAILED DESCRIPTION OF THE EMBODIMENT

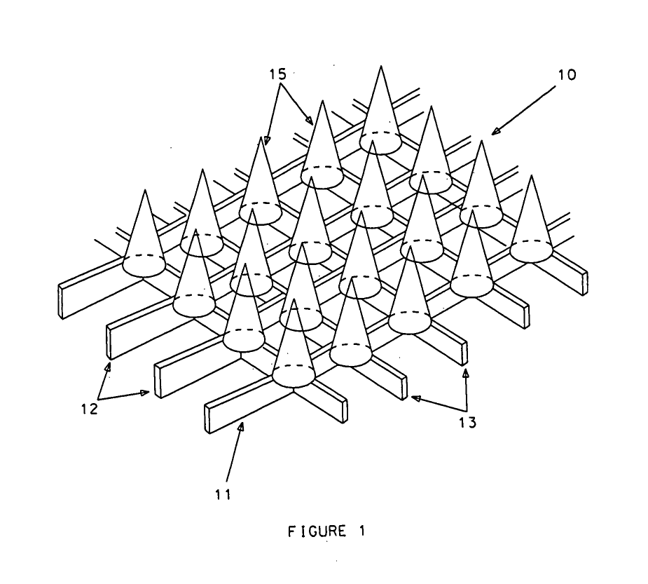

Referring now to the drawings, wherein like reference numerals refer to the same components across the several views and in particular to FIG. 1, there is shown an anti splatter cover 10. The anti splatter cover 10 includes a substantially rectangular mesh cover 11, which is composed of a grid of substantially square areas interconnected to one another to allow a fluid to drop through into a drain pan. The substantially rectangular mesh cover 11 is formed generally by an intersection of a plurality of horizontal beams 12 with a plurality of vertical beams 13.

Mounted at the points of intersection of the plurality of horizontal beams 12 and the plurality of vertical beams 13 are a plurality of protrusions 15. The plurality of protrusions 15 are generally conical in shape and extend upwardly, generally perpendicularly from the substantially rectangular mesh cover 11. In a preferred embodiment of the present invention, the plurality of protrusions 15 are formed directly into the substantially rectangular mesh cover 11, essentially making it one unit, however, any mounting technique known to one of ordinary skill in the art may be employed to mount the plurality of protrusions 15 to the substantially rectangular mesh cover 11.

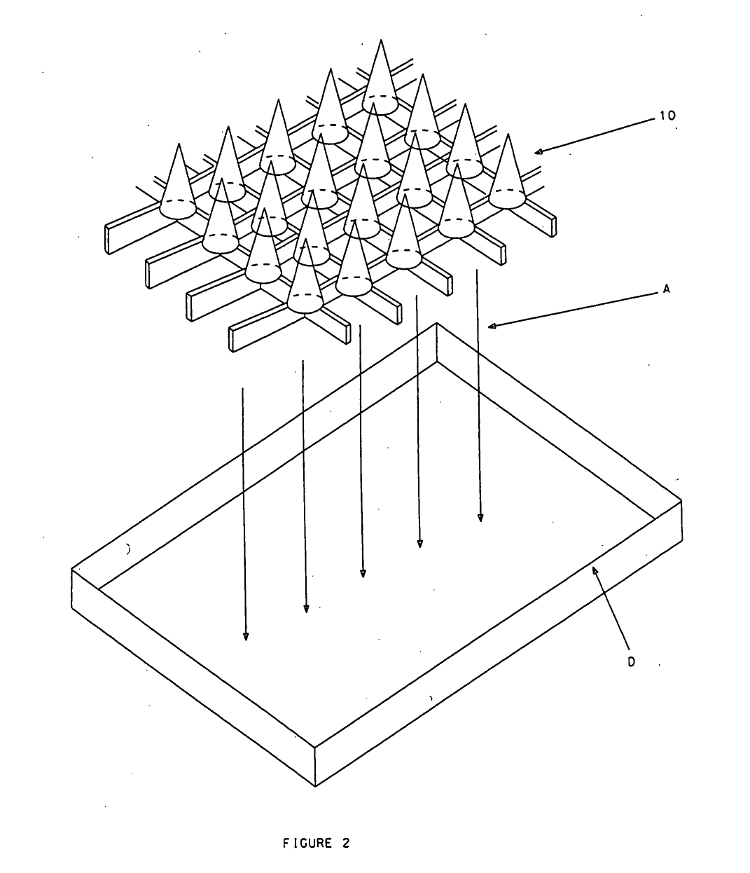

Referring now to FIG. 2, a representative use of the anti splatter cover 10 can be seen. The anti splatter cover 10 is mounted onto a drain pan ‘D’ by lowering the anti splatter cover 10 in the direction of arrow ‘A’. As oil, or any other liquid drips down into the drain pan ‘D’, it typically first comes into contact with the plurality of protrusions 15, which break the fall of the liquid. This reduction in velocity of the liquid causes the impact of the liquid to be far less than the liquid would have impacted the drain pan ‘D’ without the break. As a result, the amount of splatter is greatly reduced.

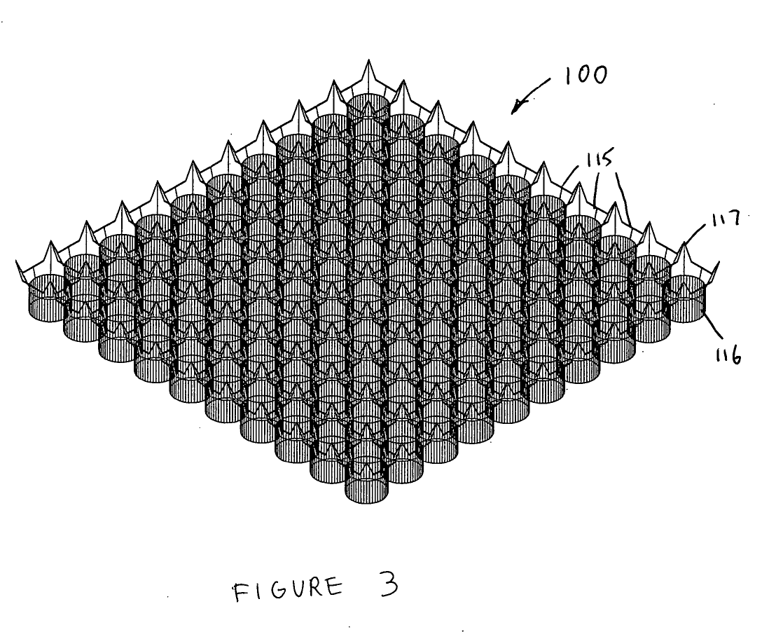

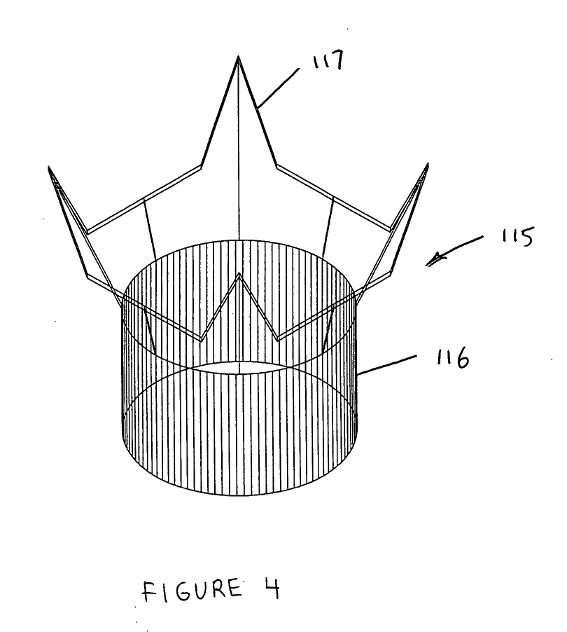

Referring now to FIGS. 3 and 4, an alternative embodiment of the anti splatter cover 100 is shown. The anti splatter cover 100 includes a plurality of crown shaped protrusions 115. The crown shaped protrusions 115 include substantially cylindrical portions 116 and crowns 117. The crowns 117 are mounted at the top of the substantially cylindrical portions 116 to direct a falling liquid down into the substantially cylindrical portions 116.

In view of the foregoing disclosure, some advantages of the present invention can be seen. For example, a novel anti splatter cover is disclosed. The novel anti splatter cover is easily placed on a drain pan to prevent splatter from a dripping liquid. The novel anti splatter cover includes a plurality of conical protrusions so as to reduce the velocity of the dripping fluid being drained, thereby reducing the splatter. Furthermore, the novel anti splatter cover can be easily used by placement into a conventional drainpan making cleanup easier.

While the preferred embodiments of the present invention have been described and illustrated, modifications may be made by one of ordinary skill in the art without departing from the scope and spirit of the invention as defined in the appended claims. For example, in a preferred embodiment of the present invention, the mesh is described as being substantially rectangular, and the protrusions are described as being generally conical, however any known shape to one of ordinary skill in the art may be employed. Additionally, in a preferred embodiment of the present invention, the anti splatter cover is formed of polyethylene, and by injection molding, vacuum forming, or pressure forming. However, any material known to one of ordinary skill in the art may be employed, and any method of producing the anti splatter cover known to one of ordinary skill in the art may be employed. In a preferred embodiment of the present invention, the fluid typically drained would be oil from an automotive engine, and the anti splatter cover would be placed a certain distance beneath the engine. However, any fluid can be drained using the anti splatter cover, and any configuration and distance known to one of ordinary skill in the art may be employed. Additionally, the mesh of the anti splatter cover in a preferred embodiment of the present invention is described as being substantially rectangular, however, any known shape may be employed to form the mesh.

1. An anti splatter cover for a drain pan, comprising:
a substantially rectangular mesh cover for covering the drain pan; and
at least one protrusion mounted perpendicularly to the substantially rectangular mesh cover.

2. The anti splatter cover of claim 1, further comprising a plurality of protrusions mounted perpendicularly to the substantially rectangular mesh cover.

3. The anti splatter cover of claim 2, wherein the plurality of protrusions are conically shaped.

4. The anti splatter cover of claim 1, wherein the anti splatter cover is formed of polyethylene.

5. The anti splatter cover of claim 4, wherein the anti splatter cover is formed by injection molding, vacuum forming, or pressure forming.

6. The anti splatter cover of claim 1, wherein the substantially rectangular mesh cover further comprises a plurality of intersecting horizontal beams and vertical beams.

7. The anti splatter cover of claim 6, wherein the at least one protrusion is mounted at an intersection of the horizontal and vertical beams.

8. An anti splatter cover for a drain pan, comprising:
a substantially rectangular mesh cover for covering the drain pan including a plurality of intersecting horizontal beams and vertical beams; and
a plurality of conical protrusions, mounted perpendicularly at the intersections of the horizontal and vertical beams of the substantially rectangular mesh cover.

9. The anti splatter cover of claim 8, wherein the anti splatter cover is formed of polyethylene.

10. The anti splatter cover of claim 9, wherein the anti splatter cover is formed by injection molding, vacuum forming, or pressure forming.

11. An anti splatter cover for a drain pan, comprising:
a mesh cover for covering the drain pan; and
at least one protrusion mounted perpendicularly to the substantially rectangular mesh cover.

12. The anti splatter cover of claim 11, further comprising a plurality of protrusions mounted perpendicularly to the mesh cover.

13. The anti splatter cover of claim 12, wherein the plurality of protrusions are conically shaped.

14. The anti splatter cover of claim 11, wherein the anti splatter cover is formed of polyethylene.

15. The anti splatter cover of claim 14, wherein the anti splatter cover is formed by injection molding, vacuum forming, or pressure forming.

16. The anti splatter cover of claim 11, wherein the mesh cover further comprises a plurality of intersecting horizontal beams and vertical beams.

17. The anti splatter cover of claim 16, wherein the at least one protrusion is mounted at an intersection of the horizontal and vertical beams.

18. An anti splatter cover, comprising:
a substantially rectangular mesh cover for covering the drain pan including a plurality of intersecting horizontal beams and vertical beams; and
a plurality of crown shaped protrusions, including a crown portion mounted on a substantially cylindrical portion.
